(19) United States
(12) Patent Application Publication
(10) Pub. No.: US 2011/0102324 A1
(43) Pub. Date: May 5, 2011

(54) METHOD AND APPARATUS FOR PROVIDING USER INTERFACE BASED ON PHYSICAL ICON

(75) Inventor: Cheol-ju HWANG, Yongin-si (KR)

(73) Assignee: SAMSUNG ELECTRONICS CO., LTD., Suwon-si (KR)

(21) Appl. No.: 12/706,183

(22) Filed: Feb. 16, 2010

(30) Foreign Application Priority Data
Nov. 4, 2009 (KR) 10-2009-0105983

(51) Int. Cl. G09G 5/00

(52) U.S. Cl. 345/168

(57) ABSTRACT

A method of providing a user interface based on a physical icon (PHYCON), the method including: obtaining information required for executing an application from a PHYCON constituting a recording medium on which the information is recorded, by using a communication medium; and controlling to execute the application by using the information obtained from the PHYCON.

### CROSS-REFERENCE TO RELATED PATENT APPLICATION

This application claims priority from Korean Patent Application No. 10-2009-0105983, filed on Nov. 4, 2009, in the Korean Intellectual Property Office, the disclosure of which is incorporated herein in its entirety by reference.

### BACKGROUND

1. Field

Apparatuses and methods consistent with the exemplary embodiments relate to providing a user interface based on a physical icon (PHYCON), and more particularly, to providing a user interface based on a PHYCON, wherein a function desired by a user and data required for the function are stored in the PHYCON, and the function is performed as the user performs an action, such as placing the PHYCON on a desired device for performing the function.

2. Description of the Related Art

In order for a device to perform a particular function, a user may activate an application program by using a menu of the device, and may provide data required for the activated application program.

For example, when the user wants to access a web site, the user first executes a web browser on a menu of a device, and may access the web site by inputting an address of the web site on an address input window of the web browser, or by using a Favorites list that includes the address of the web site to select the address.

Alternatively, when the user wants to use an Internet phone, the user first executes an Internet phone application program, such as Skype, in a terminal, such as a laptop, supporting an Internet phone, and uses the Internet phone by directly inputting a phone number of a callee or by using an address book including the phone number of the callee.

### SUMMARY

Apparatuses and methods consistent with the one or more exemplary embodiments relate to providing a user interface based on a physical icon (PHYCON), wherein a function desired by a user and data required for the function are stored in the PHYCON, and the function is performed as the user performs an action, such as placing the PHYCON on a desired device for performing the function.

One or more exemplary embodiments also provide a computer readable recording medium having recorded thereon a program for executing the method.

One or more exemplary embodiments also provide a method of providing a user interface based on a physical icon (PHYCON), the method including: obtaining information required to execute an application from a PHYCON that includes a recording medium on which the information is recorded, by using a communication medium; and controlling to execute the application by using the information obtained from the PHYCON.

The communication medium may include radio frequency identification (RFID), a bar code, Bluetooth, HomeRF, infrared data association (IrDA), or ZigBee.

The information may include at least one of an application identifier or input data of the application.

The application may include a web browser application, an Internet phone application, a user information input request application, and a video on demand (VoD) application, and the input data of the application may include a web page address, a phone number of a callee, user information, and a VoD content identifier according to each application.

The information may include a PHYCON identifier for identifying the PHYCON in the communication medium.

The method may further include: transmitting the PHYCON identifier to a database system to provide at least one of an application identifier and input data of the application corresponding to the PHYCON identifier; and receiving at least one of the application identifier and the input data of the application from the database system.

The database system may be disposed inside an apparatus for providing a user interface based on the PHYCON, or outside the apparatus by being connected to the apparatus through the Internet.

The PHYCON may indicate the information on a surface of the PHYCON, or indicates the information in a shape of the PHYCON.

One or more exemplary embodiments also provide a computer readable recording medium having recorded thereon a program for executing the method.

One or more exemplary embodiments also provide an apparatus for providing a user interface based on a physical icon (PHYCON), the apparatus including: a PHYCON reader for obtaining information required to execute an application from a PHYCON that includes a recording medium on which the information is recorded, by using a communication medium; and an application launcher to control the execution of the application using the information obtained from the PHYCON.

One or more exemplary embodiments also provide a system for providing user information to a device, the system including: a PHYCON having a recording medium that stores information including an application identifier and application input information; a device configured to receive the information from the PHYCON and to execute an application in response the received information, wherein the application executed is identified using the application identifier and the application utilizes the application input information.

One or more exemplary embodiments also provide a method for providing user information to a device, the method including: storing information including an application identifier and application input information on a physical icon (PHYCON); receiving, by a device, the information from the PHYCON; executing an application in response to the received information, wherein the executing the application includes identifying the application using the application identifier and utilizing the application input information with the application.

### BRIEF DESCRIPTION OF THE DRAWINGS

The above and other aspects will become more apparent by describing in detail exemplary embodiments thereof with reference to the attached drawings in which:

FIG. 1 is a diagram illustrating a physical shape of a physical icon (PHYCON) viewed from the side, according to an exemplary embodiment;

FIG. 2 is a diagram illustrating physical shapes of PHYCONs viewed from above;

FIG. 3 is a block diagram of an apparatus for providing a user interface based on a PHYCON;

FIG. 4 is a block diagram of an apparatus for providing a user interface based on a PHYCON;

FIG. 5 is a block diagram of an apparatus for providing a user interface based on a PHYCON; and

FIG. 6 is a flowchart illustrating a method of providing a user interface based on a PHYCON.

### DETAILED DESCRIPTION OF THE EXEMPLARY EMBODIMENTS

Hereinafter, the exemplary embodiments will be described more fully with reference to the accompanying drawings. In the drawings, like reference numerals denote like elements, and the sizes of elements may be exaggerated for clarity.

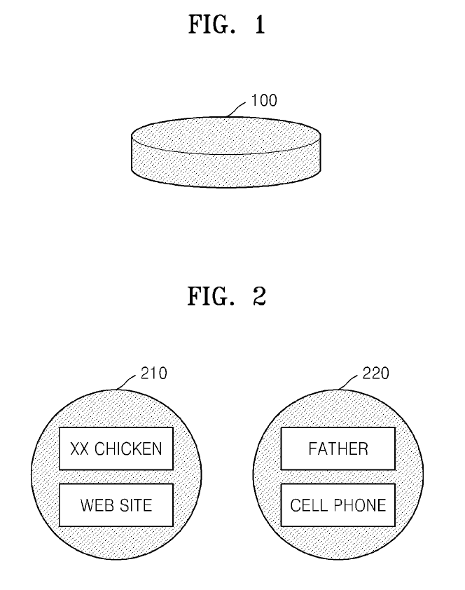

FIG. 1 is a diagram illustrating a physical shape of a physical icon (PHYCON) 100 viewed from the side, according to an exemplary embodiment.

The PHYCON 100 denotes a recording medium having recorded thereon information required to execute an application. The physical shape of the PHYCON 100 shown in FIG. 1 is a thin cylindrical shape, but as would be obvious to one of ordinary skill in the art, the physical shape of the PHYCON 100 may vary. For example, the PHYCON may take the shape of a cube, pyramid and a sphere, but is not limited thereto.

The PHYCON 100 includes a communication medium (not shown) for communication with a PHYCON reader. The communication medium of the PHYCON 100 may be based on radio frequency identification (RFID) system, a bar code system, Bluetooth, HomeRF, infrared data association (IrDA), and ZigBee, but is not limited thereto.

FIG. 2 is a diagram illustrating physical shapes of PHYCONs 210 and 220 viewed from above.

As shown in FIG. 2, the PHYCONs 210 and 220 indicate information required to execute an application on surfaces thereof so that a user identifies the PHYCONS 210 and 220. In FIG. 2, the information is indicated with text, but the information may be indicated with different methods of indicating information, such as by using an image. Additionally, the information may be identified from a shape of a PHYCON. Here, the user may identify a PHYCON through the shape of the PHYCON.

In the PHYCON 210, “Web Site” is indicated for the user to easily understand an application name, such as a web browser application, and “XX Chicken” is indicated for the user to easily understand data, such as a web page address of XX Chicken, required by the web browser application. Also, in the PHYCON 220, “Cell Phone” is indicated for the user to easily understand an application name, such as an Internet phone application, and “Father” is indicated for the user to easily understand data, such as a cell phone number of the user's father, required by the Internet phone application.

A user scenario that is exemplary for using the PHYCON 210 indicated with “Web Site” and “XX Chicken” is as follows.

A business proprietor A who started a fried chicken delivery service requests a PHYCON manufacturer to manufacture the PHYCON 210 with a logo of his/her company. If the PHYCON 210 is implemented based on RFID technology, the PHYCON 210 may be manufactured at a very low price. Here, the PHYCON manufacturer may add data for mapping the RFID of the PHYCON 210 with an application name, such as a web browser application, and required data, such as an ordering web page address of the business proprietor A, to a database system. Also, the PHYCON manufacturer may add a magnet to the PHYCON 210 so that the PHYCON 210 may easily adhere to a refrigerator, for example.

The business proprietor A distributes a plurality of the PHYCONs 210 to apartment buildings or houses nearby. A user may attach the PHYCON 210 on a refrigerator. When the user wants to order fried chicken, the user places the PHYCON 210 on a liquid crystal display (LCD) of the refrigerator. A PHYCON reader of the LCD reads the RFID tag of the PHYCON 210, and then transmits a question to and receives a response from the database system through a network, thereby obtaining the application name, i.e., the web browser application, and the required data, i.e., the ordering web page address. The PHYCON reader transmits the application name and the required data to an application launcher of the LCD so as to execute the web browser application and input the ordering web page address on an address input window. After some time, the LCD displays an ordering web site of the business proprietor A, and the user may order a desired number of menu items for delivery to a desired address.

Meanwhile, when the business proprietor A distributes the PHYCONs 210, the business proprietor A may include discount information in the PHYCONs 210. Accordingly, when the user orders fried chicken from the ordering web site of the business proprietor A, the user may get a discount based on the discount information.

Here, the application launcher may recommend another chicken delivery service to the user after obtaining information that the user wants to order fried chicken from the business proprietor A.

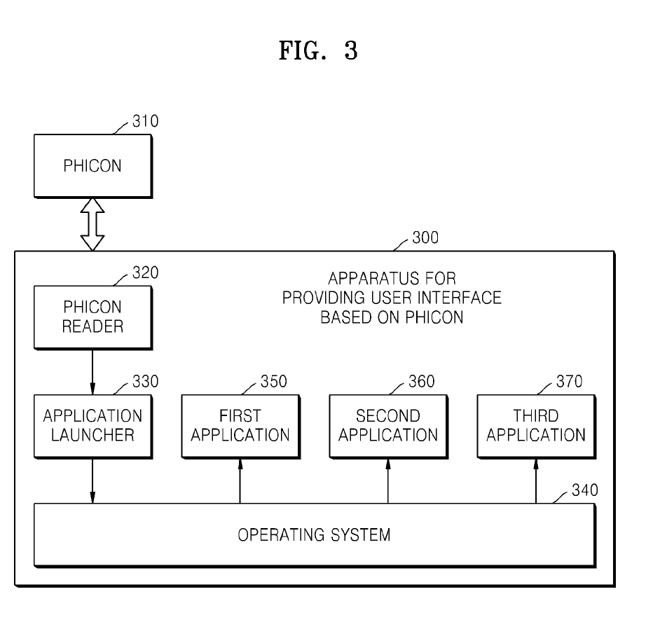

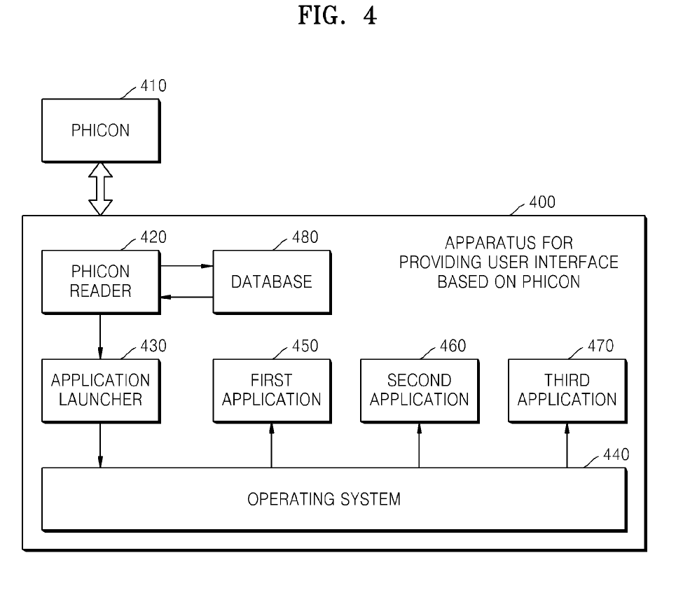

FIG. 3 is a block diagram of an apparatus 300 for providing a user interface based on a PHYCON 310, according to an exemplary embodiment.

The apparatus 300 includes a PHYCON reader 320 and an application launcher 330.

The PHYCON reader 320 obtains information required to execute an application from the PHYCON 310, which is a recording medium on which the information is recorded, by using a communication medium. Examples of the communication medium for connecting the PHYCON 310 and the PHYCON reader 320 include RFID, a bar code system, Bluetooth, HomeRF, IrDA, and ZigBee, but the communications mediums are not limited thereto.

The information recorded on the PHYCON 310 includes at least one of an application identifier and input data of the application, but other information may be included in the PHYCON 310.

When the application is a web browser application, the information includes at least one of an application name, i.e. a web browser application, and a web page address to be input to the web browser application.

When the application is an Internet phone application, the information includes at least one of an application name, i.e. an Internet phone application, and a phone number of a callee.

When the application is a user information input request application, the information includes at least one of an application name, i.e. a user information input request application, and user information, such as an address of a user. By using the apparatus 300, the user may easily input the user information to various types of applications that request user information.

For example, when the user information input request application is an address book application, the PHYCON reader 320 may obtain user identification information from the PHYCON 310, such as a business card PHYCON, including the user identification information, and the application launcher 330 that will be described later may control execution of the address book application by using the user identification information as an input. The user may easily input the user identification information to the address book application by using the apparatus 300.

Alternatively, when the user information input request application is an ordering application, the PHYCON reader 320 may obtain delivery address information from the PHYCON 310 that includes the delivery address information, and the application launcher 330 may control execution of the ordering application by automatically inputting the delivery address information to the address application that is being executed.

Alternatively, when the application is a video on demand (VoD) application, the information includes at least one of an application name, i.e., a VoD service providing application, and a VoD content identifier. A VoD service corporation may manufacture and sell the PHYCON 310 about certain content. A user may download VoD content at the apparatus 300 through the VoD service providing application, wherein the VoD content is identified by the VoD content identifier, and may use the downloaded VoD content.

The application launcher 330 may control an operating system 340 to execute a first application 350, a second application 360 and a third application 370, by using the information obtained from the PHYCON 310. In order for the application launcher 330 to execute the first through third applications 350 through 370 by using the operating system 340, the information required to execute the first through third applications 350 through 370 is provided to the operating system 340 as application input parameters. These input parameters may be received from the PHYCON 310.

For example, when the application is a web browser application, the application launcher 330 provides the information including the application name and the web page address to the operating system 340 as application input parameters, so as to execute the web browser application through the operating system 340.

The application launcher 330 may control the operating system 340 to execute the first through third applications 350 through 370 by using the information obtained from the PHYCON 310 through the PHYCON reader 320, but as would be understood by one of ordinary skill in the art that the application launcher 330 may process the information before providing the information to the operating system 340.

For example, when the application launcher 330 obtains only the input data from the PHYCON reader 320, the application launcher 330 may provide an identifier of a default application or an application selected according to a predetermined priority to the operating system 340. In this case, the identifier is used with the input data as application input parameters, so as to control the operating system 340 to execute corresponding first through third applications 350 through 370.

According to an exemplary embodiment, a user may easily execute a desired application by omitting a process of selecting an application on a user interface and inputting data required for the selected application. Also, since a PHYCON is a tangible object, anyone can easily execute a desired function, thereby providing an interface familiar to a user.

Also, according to an exemplary embodiment, a user interface is simplified to ease the burden of executing a desired application according to a complicated menu structure. Additionally, the process of inputting various types of input data into an input window may also be avoided. Specifically, considering that the menu structures of multifunctional devices are becoming more complicated, simplifying a user interface may be a good solution. In other words, a user may execute a desired function only by placing a PHYCON on a device for performing the desired function without having to learn how to use the device.

FIG. 4 is a block diagram of an apparatus 400 for providing a user interface based on a PHYCON 410, according to another exemplary embodiment.

The apparatus 400 includes a PHYCON reader 420, an application launcher 430, and a database system 480.

The PHYCON reader 420 obtains information required to execute an application from the PHYCON 410, which is a recording medium on which the information is recorded, by using a communication medium. Examples of the communication medium for connecting the PHYCON 410 and the PHYCON reader 420 include RFID, a bar code system, Bluetooth, HomeRF, IrDA, and ZigBee.

The information recorded on the PHYCON 410 includes a PHYCON identifier for identifying the PHYCON 410, but as would be obvious to one of ordinary skill in the art, the information may include other information.

The PHYCON reader 420 includes a PHYCON identifier transmitter (not shown) and an application information receiver (not shown).

The PHYCON identifier transmitter transmits the PHYCON identifier to the database system 480 for providing at least one of an application identifier and input data of an application corresponding to the PHYCON identifier. The database system 480 may be included in the apparatus 400.

The application information receiver receives at least one of the application identifier and the input data from the database system 480.

When the application is a web browser application, the application identifier denotes a name of the web browser application, and the input data denotes a web page address to be input to the web browser application.

When the application is an Internet phone application, the application identifier denotes a name of the Internet phone application, and the input data denotes a phone number of a callee.

When the application is a user information input request application, the application identifier denotes a name of the user information input request application, and the input data denotes user information, such as an address of a user.

When the application is a VoD application, the application identifier denotes a name of a VoD service providing application, and the input data denotes a VoD content identifier.

The application launcher 430 controls an operating system 440 to execute a first application 450, a second application 460 and a third application 470 using the information obtained from the PHYCON 410 through the PHYCON reader 420. In order to execute the first through third applications 450 through 470 using the operating system 440, the application launcher 430 provides information required to execute the first through third applications 450 through 470 to the operating system 440 as application input parameters.

For example, when the application is a web browser application, the application launcher 430 provides the information including the name of the web browser application and the web page address to the operating system 440 as application input parameters so as to execute the web browser application through the operating system 440.

The application launcher 430 may control the operating system 440 to execute one of the first through third applications 450 through 470 by using the information obtained from the PHYCON 410 through the PHYCON reader 420, but as would be obvious to one of ordinary skill in the art, the application launcher 430 may process the information before providing the information to the operating system 440.

For example, when the application launcher 430 obtained only the input data from the PHYCON 410 through the PHYCON reader 420, the application launcher 430 may provide an identifier of a default application or an application selected according to predetermined priority to the operating system 440. In this case, the identifier is used with the input data as application input parameters, so as to control the operating system 440 to execute corresponding first through third applications 450 through 470.

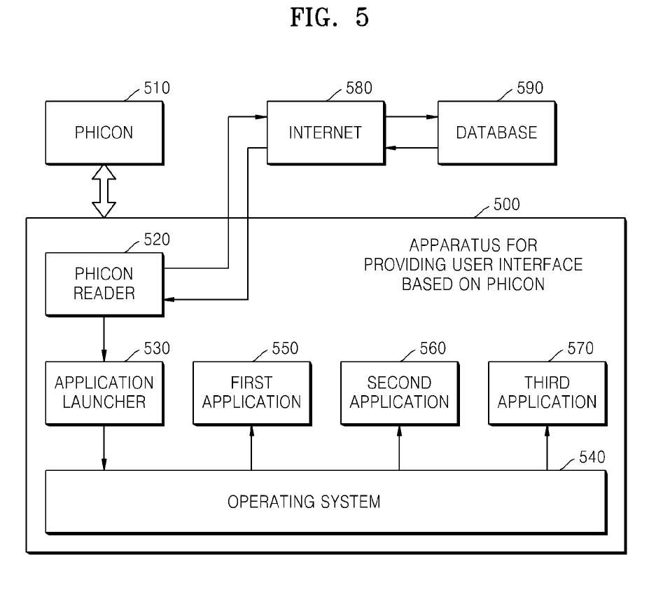

FIG. 5 is a block diagram of an apparatus 500 for providing a user interface based on a PHYCON 510, according to another exemplary embodiment.

The apparatus 500 includes a PHYCON reader 520 and an application launcher 530.

The PHYCON reader 520 obtains information required to execute an application from the PHYCON 510, which is a recording medium on which the information is recorded, by using a communication medium. Examples of the communication medium for connecting the PHYCON 510 and the PHYCON reader 520 include RFID, a bar code system, Bluetooth, HomeRF, IrDA, and ZigBee.

The information recorded on the PHYCON 510 includes a PHYCON identifier for identifying the PHYCON 510, but as would be obvious to one of ordinary skill in the art, the information may include other information.

The PHYCON reader 520 includes a PHYCON identifier transmitter (not shown) and an application information receiver (not shown).

The PHYCON identifier transmitter transmits the PHYCON identifier to a database system 590 through the Internet 580 to provide at least one of an application identifier and input data of an application corresponding to the PHYCON identifier. The database system 590 may be disposed outside the apparatus 500 by being connected to the apparatus 500 through the Internet 580.

The application information receiver receives at least one of the application identifier and the input data from the database system 590.

The application launcher 530 controls an operating system 540 to perform first through third applications 550 through 570 by using the information obtained from the PHYCON 510 through the PHYCON reader 520. In order to execute the first through third applications 550 through 570 through the operating system 540, the application launcher 530 provides information required to execute the first through third applications 550 through 570 to the operating system 540 as application input parameters.

For example, when the application is a web browser application, the application launcher 530 provides the information including the name of the web browser application and the web page address to the operating system 540 as application input parameters so as to execute the web browser application through the operating system 540.

The application launcher 530 may control the operating system 540 to execute one of the first through third applications 550 through 570 by using the information obtained from the PHYCON 510 through the PHYCON reader 520, but as would be obvious to one of ordinary skill in the art, the application launcher 530 may process the information before providing the information to the operating system 540.

For example, when the application launcher 530 obtained only the input data from the PHYCON 510 through the PHYCON reader 520, the application launcher 530 may provide an identifier of a default application or an application selected according to priority to the operating system 540. In this case, the identifier is used with the input data as application input parameters, so as to control the operating system 540 to execute corresponding first through third applications 550 through 570.

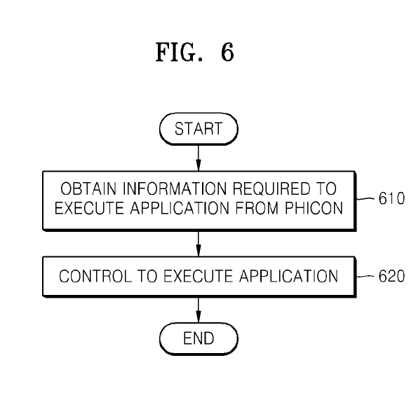

FIG. 6 is a flowchart illustrating a method of providing a user interface based on a PHYCON, according to an exemplary embodiment.

In operation 610, an apparatus for providing a user interface obtains information required to execute an application from a PHYCON, which is a recording medium on which the information is recorded, through a communication medium.

Examples of the communication medium include RFID, a bar code system, Bluetooth, HomeRF, IrDA, and Zigbee, but are not limited thereto.

The information according to an exemplary embodiment may include at least one of an application identifier and input data of an application. Examples of the application include a web browser application, an Internet phone application, a user information input request application, and a VoD application. The input data may include a web page address, a phone number of a callee, user information, and a VoD content identifier, depending on the application.

The information according to an exemplary embodiment includes a PHYCON identifier for identifying a PHYCON in a communication medium. Here, the apparatus transmits the PHYCON identifier to a database system for providing at least one of an application identifier and input data of the application corresponding to the PHYCON identifier. The apparatus receives at least one of the application identifier and the input data from the database system.

The database system may be included inside the apparatus or outside the apparatus by being connected, for example, to the apparatus through the Internet.

In operation 620, the apparatus executes an application by using the information obtained from the PHYCON. For example, the apparatus executes a web browser application through an operating system by providing the information to the operating system as an application input parameter.

For example, the apparatuses 300, 400 and 500 of FIGS. 3 through 5 may include a bus coupled to each element of the apparatuses 300 through 500, at least one processor coupled to the bus, and a memory coupled to the bus so as to store a command, a received message, or a generated message, and coupled to the at least one processor so as to perform commands described above.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of providing a user interface based on a physical icon (PHYCON), the method comprising:
obtaining information required to execute an application from a PHYCON that includes a recording medium on which the information is recorded, by using a communication medium; and
controlling to execute the application by using the information obtained from the PHYCON.

2. The method of claim 1, wherein the communication medium comprises radio frequency identification (RFID), a bar code, Bluetooth, HomeRF, infrared data association (IrDA), or ZigBee.

3. The method of claim 1, wherein the information comprises at least one of an application identifier or input data of the application.

4. The method of claim 3, wherein the application comprises at least one of a web browser application, an Internet phone application, a user information input request application, and a video on demand (VoD) application, and
the input data of the application comprises at least one of a web page address, a phone number of a callee, user information, and a VoD content identifier according to each application.

5. The method of claim 1, wherein the information comprises a PHYCON identifier for identifying the PHYCON in the communication medium.

6. The method of claim 5, further comprising:
transmitting the PHYCON identifier to a database system for providing at least one of an application identifier and input data of the application corresponding to the PHYCON identifier; and
receiving at least one of the application identifier and the input data of the application from the database system.

7. The method of claim 6, wherein the database system is disposed inside an apparatus for providing a user interface based on the PHYCON, or outside the apparatus by being connected to the apparatus through the Internet.

8. The method of claim 1, wherein the PHYCON indicates the information on a surface of the PHYCON, or indicates the information in a shape of the PHYCON.

9. An apparatus for providing a user interface based on a physical icon (PHYCON), the apparatus comprising:
a PHYCON reader that obtains information required to execute an application from a PHYCON that includes a recording medium on which the information is recorded, by using a communication medium; and
an application launcher that controls the execution of the application using the information obtained from the PHYCON.

10. The apparatus of claim 9, wherein the communication medium comprises radio frequency identification (RFID), a bar code, Bluetooth, HomeRF, infrared data association (IrDA), or ZigBee.

11. The apparatus of claim 9, wherein the information comprises at least one of an application identifier or input data of the application.

12. The apparatus of claim 11, wherein the application comprises at least one of a web browser application, an Internet phone application, a user information input request application, and a video on demand (VoD) application, and
the input data of the application comprises at least one of a web page address, a phone number of a callee, user information, and a VoD content identifier according to each application.

13. The apparatus of claim 9, wherein the information comprises a PHYCON identifier for identifying the PHYCON in the communication medium.

14. The apparatus of claim 13, further comprising:
a PHYCON identifier transmitter that transmits the PHYCON identifier to a database system to provide at least one of an application identifier and input data of the application corresponding to the PHYCON identifier; and
an application information receiver that receives at least one of the application identifier and the input data of the application from the database system.

15. The apparatus of claim 14, wherein the database system is disposed inside the apparatus or outside the apparatus by being connected to the apparatus through the Internet.

16. The apparatus of claim 9, wherein the PHYCON indicates the information on a surface of the PHYCON, or indicates the information in a shape of the PHYCON.

17. A computer readable recording medium having recorded thereon a program for executing the method of claim 1.

18. A system for providing user information to a device, the system comprising:
a physical icon (PHYCON) having a recording medium that stores information including an application identifier and application input information;
a device configured to receive the information from the PHYCON and to execute an application in response the received information,
wherein the application executed is identified using the application identifier and the application utilizes the application input information.

19. A method for providing user information to a device, the method comprising:
storing information including an application identifier and application input information on a physical icon (PHYCON);
receiving, by a device, the information from the PHYCON;
executing an application in response to the received information,
wherein the executing the application includes identifying the application using the application identifier and utilizing the application input information with the application.
